(19) United States
(12) Patent Application Publication
(10) Pub. No.: US 2011/0244791 A1
(43) Pub. Date: Oct. 6, 2011

(54) Transmission/Reception Systems and Receivers, and Skew Compensation Methods Thereof

(76) Inventor: Mookyung Kang, Seoul (KR)

(21) Appl. No.: 13/007,171

(22) Filed: Jan. 14, 2011

(30) Foreign Application Priority Data
Apr. 2, 2010 (KR) 10-2010-0030196

(51) Int. Cl. H04B 7/00; H04B 7/24

(52) U.S. Cl. 455/39; 455/230

(57) ABSTRACT

Provided are transmission/reception systems, transmission/reception receivers, and skew compensation methods thereof. A transmission/reception receiver may include delay compensators connected to respective data lines. The receiver may also include a detector configured to detect arrival time points of data signals input through the data lines. The receiver may further include a delay controller configured to control each of the delay compensators based on the detected arrival time points to output data signals transmitted through the data lines at a same time point through the delay compensators.

### CROSS-REFERENCE TO RELATED APPLICATIONS

This U.S. non-provisional patent application claims priority under 35 U.S.C. §119 to Korean Patent Application No. 10-2010-0030196, filed on Apr. 2, 2010, the disclosure of which is hereby incorporated by reference in its entirety.

### BACKGROUND

The present disclosure herein relates to transmission/reception systems, and more particularly, to transmission/reception systems and receivers and skew compensation methods thereof.

A transmitter and a receiver may include a plurality of data lines to transmit or receive high-speed and/or large data. The transmitter may divide the data into a plurality of data lines and then transmit the data. The receiver may receive the data through a plurality of data lines and may restore the received data.

For example, a plurality of data lines may be between a transmitter (i.e., a transmitter IC) and a receiver (i.e., a receiver IC) on a printed circuit board (PCB). Due to space limitations of PCBs having a plurality of chips, data lines between chips may not have the same length. Data transmission over a relatively long data line may be delayed compared with data transmission over a relatively short data line. The transmission delay between data lines may cause skew with respect to data received through a plurality of lines in a receiver.

### SUMMARY

The present disclosure provides transmission/reception systems and receivers for accurately/normally restoring data transmitted from transmitters, and further provides skew compensation methods thereof.

The present disclosure also provides transmission/reception systems and receivers for compensating for skew of data received between a plurality of data lines, and skew compensation methods thereof.

Some embodiments provide a receiver including delay compensators connected to respective data lines. In some embodiments, the receiver may also include a detector configured to detect arrival time points of respective data signals input through the data lines to provide detected arrival time points. In some embodiments, the receiver may further include a delay controller configured to control the delay compensators based on the detected arrival time points to output the data signals from the delay compensators at a same time point to provide delay-compensated data signals.

In some embodiments, each of the data signals may include start data that represent a transmission start of the respective data signals.

In some embodiments, the detector may be configured to detect different ones of the arrival time points using predetermined values of the start data.

In other embodiments, the delay controller may be configured to delay the data signals based on the detected arrival time points.

In some embodiments, the delay controller may be configured to delay each of the data signals except for at least one of the data signals having a latest one of the detected arrival time points.

In some embodiments, the receiver may further include buffers connected to the respective data lines, and the detector may be connected between the buffers and the delay compensators.

In some embodiments, the receiver may further include a combiner that may be configured to combine the delay-compensated signals to provide a restored data signal.

In some embodiments, the receiver may further include a core that may be configured to process the restored data signal.

In some embodiments, the combiner may be configured to combine word units from the delay-compensated data signals to provide the restored data signal.

In some embodiments, the delay controller may be configured to provide boundary information for the data signals to the delay compensators.

In some embodiments, the boundary information may include starting time points and ending time points of word data included in the data signals.

In some embodiments, a skew compensation method of a receiver may include detecting arrival time points of data signals input through respective data lines to provide detected arrival time points. In some embodiments, the method may also include controlling delay compensators receiving respective ones of the data signals based on the detected arrival time points to output the data signals at a same time point to provide delay-compensated data signals.

In some embodiments, each of the data signals may include start data that represent a transmission start of the respective data signals.

In still other embodiments, the detected arrival time points may correspond to the start data.

In some embodiments, controlling the delay compensators may further include delaying each of the data signals except for at least one of the data signals having a latest one of the detected arrival time points.

In even other embodiments, controlling the delay compensators may include delaying each of the data signals based on the detected arrival time points.

In some embodiments, the method further includes combining each of the delay-compensated data signals.

In some embodiments, a transmitter may include a data generator that may be configured to generate a data signal. In some embodiments, the transmitter may also include a data distributor that may be connected to the data generator, that may be configured to divide the data signal by a predetermined unit and to distribute different portions of the data signal to different data lines, and that may be further configured to transmit start data to each of the data lines before transmitting general data corresponding to the data signal.

In some embodiments, a transmission/reception system may include a transmitter that may be configured to transmit data signals through data lines. In some embodiments, the data signals may include start data that represent a transmission start of each of the respective data signals. In some embodiments, the system may also include a receiver that may be configured to detect arrival time points of the start data to provide detected arrival time points. In some embodiments, the receiver may be further configured to synchronize output time points of the data signals based on the detected arrival time points by delaying each of the data signals except for at least one of the data signals having a latest one of the detected arrival time points to provide delay-compensated data signals.

In some embodiments, the receiver of the system may include delay compensators connected to respective ones of the data lines. In some embodiments the receiver may also include a detector that may be configured to detect the arrival time points of the data signals input through the respective data lines to provide the detected arrival time points. In some embodiments, the receiver may further include a delay controller that may be configured to delay the data signals by controlling each of the delay compensators based on the detected arrival time points to output the delay-compensated data signals from the delay compensators at a same time point.

In even other embodiments, the transmission/reception system may further include a combiner that may be configured to combine the delay-compensated data signals.

### BRIEF DESCRIPTION OF THE DRAWINGS

The foregoing and other features and advantages of the disclosure will become more apparent by describing in detail exemplary embodiments thereof with reference to the following drawings:

FIG. 1 is a view illustrating a transmission/reception system according to some embodiments;

FIG. 2 is a view illustrating the transmitter of FIG. 1 according to some embodiments;

FIG. 3 is a view illustrating a division operation of the data distributor of FIG. 2 according to some embodiments;

FIG. 4 is a view illustrating the receiver shown in FIG. 1 according to some embodiments;

FIG. 5 is a view illustrating data signals received in the receiver shown in FIG. 4 according to some embodiments; and

FIG. 6 is a view illustrating an operation for compensating for skew between data signals in the delay compensator shown in FIG. 4 according to some embodiments.

FIG. 7 is a view illustrating a combination operation of the combiner shown in FIG. 4 according to some embodiments.

### DETAILED DESCRIPTION OF EXAMPLE EMBODIMENTS ACCORDING TO THE INVENTIVE CONCEPT

Example embodiments will be described below in more detail with reference to the accompanying drawings. Many different forms and embodiments are possible without deviating from the spirit and teachings of this disclosure and so the disclosure should not be construed as limited to the embodiments set forth herein. Rather, these embodiments are provided so that this disclosure will be thorough and complete, and will fully convey the scope of the disclosure to those skilled in the art. In the drawings, the sizes and relative sizes of layers and regions may be exaggerated for clarity. Like reference numbers refer to like elements throughout.

The terminology used herein is for the purpose of describing particular embodiments only and is not intended to be limiting of the embodiments. As used herein, the singular forms “a”, “an,” and “the” are intended to include the plural forms as well, unless the context clearly indicates otherwise. It will be further understood that the terms “comprises,” “comprising,” “includes,” and/or “including,” when used herein, specify the presence of stated features, steps, operations, elements, and/or components, but do not preclude the presence or addition of one or more other features, steps, operations, elements, components, and/or groups thereof.

It will be understood that when an element is referred to as being “coupled,” “connected,” or “responsive” to, or “on,” another element, it can be directly coupled, connected, or responsive to, or on, the other element, or intervening elements may also be present. In contrast, when an element is referred to as being “directly coupled,” “directly connected,” or “directly responsive” to, or “directly on,” another element, there are no intervening elements present. As used herein, the term “and/or” includes any and all combinations of one or more of the associated listed items.

It will be understood that, although the terms first, second, etc. may be used herein to describe various elements, these elements should not be limited by these terms. These terms are only used to distinguish one element from another. Thus, a first element could be termed a second element without departing from the teachings of the present embodiments.

Unless otherwise defined, all terms (including technical and scientific terms) used herein have the same meaning as commonly understood by one of ordinary skill in the art to which these embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

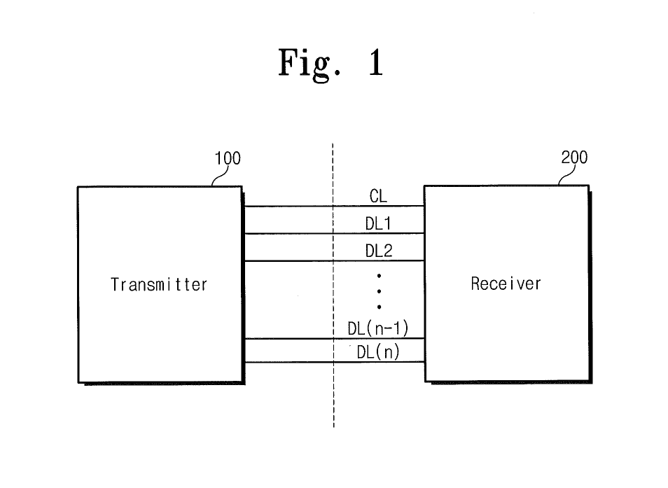

FIG. 1 is a view illustrating a transmission/reception system according to some embodiments.

Referring to FIG. 1, the transmission/reception system includes a transmitter 100 and a receiver 200.

The transmitter 100 may transmit a clock signal CLK to the receiver 200 through a clock line CL. The transmitter 100 may transmit divided data signals to the receiver 200 through a plurality of data lines DL1 to DLn. Each of the plurality of data lines DL1 to DLn may form a channel that may transmit a data signal.

The receiver 200 may receive the clock signal CLK and may then synchronize with the transmitter 100. The receiver 200 may receive data signals through the plurality of data lines DL1 to DLn. The receiver 200 may combine the received data signals based on a divided order provided by the transmitter 100.

The receiver 200 may utilize data signals with synchronized arrival time points. However, if the plurality of data lines DL1 to DLn have different lengths, arrival time points between the received data signals may not be the same.

The receiver 200 may detect each arrival time point of data signals received through the plurality of data lines DL1 to DLn, and may compensate for skew between data signals, which is generated due to a difference between arrival time points, based on the detected arrival points. As a result, data combination error due to skew between data signals may be reduced/prevented.

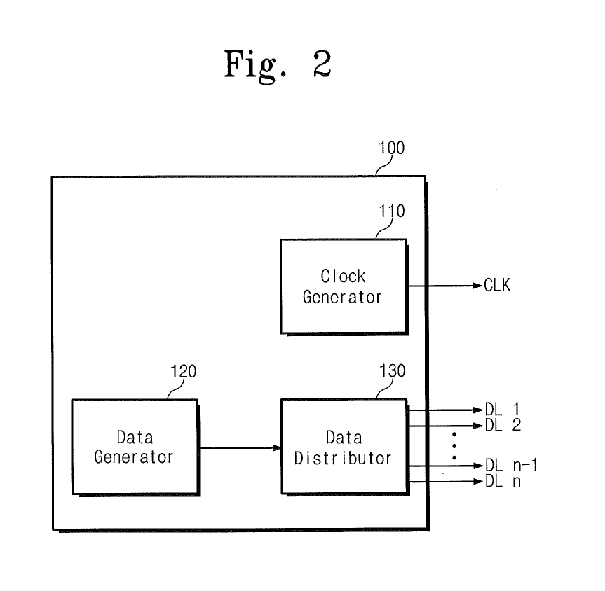

FIG. 2 is a view illustrating the transmitter of FIG. 1 according to some embodiments.

Referring to FIG. 2, the transmitter 100 may include a clock generator 110, a data generator 120, and a data distributor 130.

The clock generator 110 generates a clock signal CLK. The clock signal CLK is a signal that is transmitted in order to obtain synchronization in/with the receiver 200. The clock generator 110 transmits the clock signal CLK through the clock line CL.

The data generator 120 generates a data signal to be transmitted to the receiver 200. The data generator 120 outputs the generated data signal to the data distributor 130. The data generator 120 may generate start data that represent a transmission start of general data.

The data distributor 130 divides a data signal by a predetermined unit. The data distributor 130 transmits the divided data signals through the plurality of data lines DL1 to DLn. The data distributor 130 may transmit start data before transmitting general data with respect to each of the data signals.

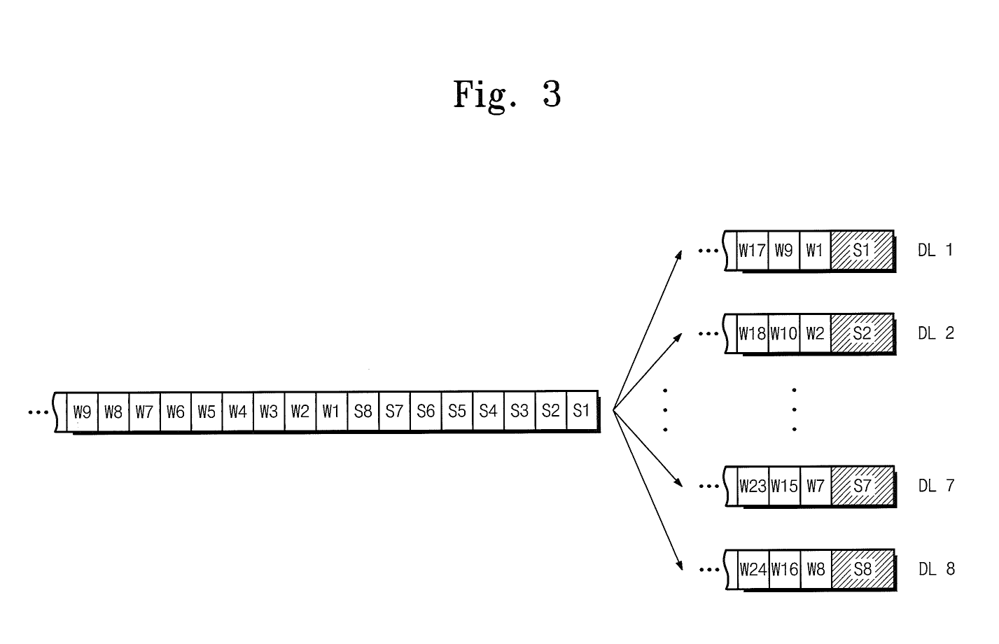

FIG. 3 is a view illustrating a division operation of the data distributor of FIG. 2 according to some embodiments.

Referring to FIG. 3, the data distributor 130 receives a data signal generated from the data generator 120. The data distributor 130 transmits data signals through data lines DL1 to DLn. For example, the data distributor 130 may transmit data signals through eight data lines DL1 to DL8. The data distributor 130 divides the data into each of the data lines DL1 to DLn by a predetermined unit. For example, the predetermined unit may be a word unit.

Assuming the example of transmitting data signals through eight data lines DL1 to DL8, the data distributor 130 divides start data S1 to S8 into each channel before transmitting general data. Each of the start data S1 to S8 may be divided with the same unit or a different unit. For example, the start data may have a predetermined data pattern (for example, 10 bits with all ‘1’s). The start data may be used for skew compensation between each of the channels in the receiver 200.

Moreover, the data distributor 130 divides word data W1, W2, W3, etc. (which are divided by a word unit) into each channel.

The data distributor 130 transmits a first data signal divided into a first channel. As illustrated in FIG. 3, assuming the example of transmitting data signals through eight data lines DL1 to DL8, the first data signal may include a first start data S1, a first word data W1, a ninth word data W9, and a seventeenth word data W17.

The data distributor 130 transmits a second data signal divided into a second channel. Still assuming the example of transmitting data signals through eight data lines DL1 to DL8, the second data signal includes a second start data S2, a second word data W2, a tenth word data W10, and an eighteenth word data W18.

In the example of transmitting data signals through eight data lines DL1 to DL8, the data distributor also transmits third, fourth, fifth, sixth, seventh, and eighth data signals into respective channels. For example, the data distributor 130 transmits a seventh data signal divided into a seventh channel. The seventh data signal includes a seventh start data S7, a seventh word data W7, a fifteenth word data W15, and a twenty-third word data W23.

Moreover, the data distributor 130 transmits an eighth data signal divided into an eighth channel. The eighth data signal includes an eighth start data S8, an eighth word data W8, a sixteenth word data W16, and a twenty-fourth word data W24.

Additionally, the data distributor 130 divides data signals into the remaining channels (i.e., a third channel through a sixth channel) in a similar manner as for the first, second, seventh, and eighth data signals, and then transmits the divided data signals.

Accordingly, assuming n data lines, the data distributor 130 divides the data signals into the plurality of data lines DL1 to DLn.

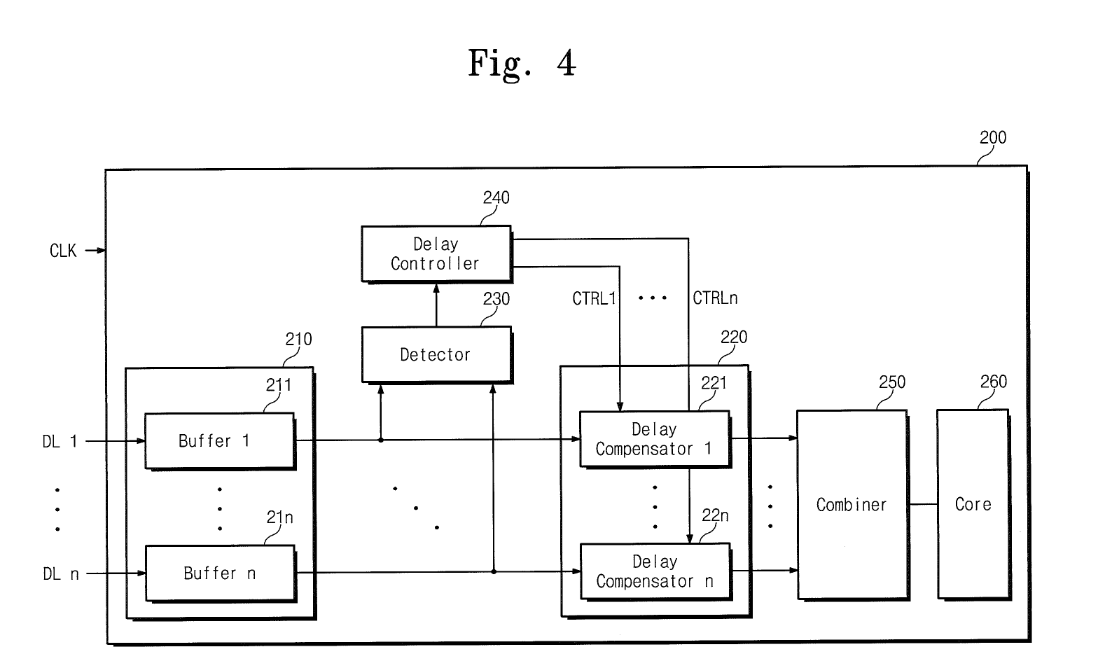

FIG. 4 is a view illustrating the receiver shown in FIG. 1 according to some embodiments.

Referring to FIG. 4, the receiver 200 may include a buffer unit 210, a delay compensator 220, a detector 230, a delay controller 240, a combiner 250, and a core 260. The receiver 200 may control data signals received through the plurality of data lines DL1 to DLn to output the data signals at the same time point.

The buffer unit 210 buffers data signals received through the plurality of data lines DL1 to DLn. The buffer unit 210 may include a first buffer 211 to an nth buffer 21n corresponding to the plurality of data lines DL1 to DLn, respectively.

The first buffer 211 to the nth buffer 21n are connected to the transmitter 100 through the plurality of data lines DL1 to DLn. The first buffer 211 buffers a first data signal received through the first data line DL1. The first buffer 211 outputs the buffered first data signal to the delay compensator 220. The nth buffer 21n buffers the nth data signal received through the nth data line DLn. The nth buffer 21n outputs the buffered nth data signal to the delay compensator 220.

The delay compensator 220 receives the buffered first data signal to the buffered nth data signal output from the buffer unit 210. The delay compensator 220 may include a first delay compensator 221 to an nth delay compensator 22n corresponding to the plurality of data lines DL1 to DLn, respectively.

In response to a first control signal CTRL1, the first delay compensator 221 compensates for a delay of the first data signal and outputs a delay-compensated first data signal. In response to an nth control signal CTRLn, the nth delay compensator 22n compensates for a delay of the nth data signal and outputs a delay-compensated nth data signal. Moreover, each of the delay compensators 221-22n may include delay devices having a delay function for delaying each data signal.

The detector 230 detects each arrival time point of buffered data signals output from the buffer unit 210. The detector 230 outputs arrival time points detected for the data lines DL1 to DLn to the delay controller 240. The detector 230 may use stored, predetermined values of the start data to detect the arrival time point for data carried on each of the data lines DL1 to DLn. In some embodiments, the detector 230 may detect an arrival of start data and provide a detected result to the delay controller 240.

The delay controller 240 controls the first delay compensator 221 to the nth delay compensator 22n in order to output all data signals at the same time point based on the detected arrival time points. The delay controller 240 may calculate delay times and apply them to the data signals based on the detected arrival time points. The delay controller 240 outputs control signals CTRL1 and CTRLn including respective delay times to the first delay compensator 221 to the nth delay compensator 22n.

The combiner 250 may combine data signals that are output at the same time point from the delay compensator 220. The combiner 250 may combine the data signals through a combination method corresponding to a division method of the data distributor 130. The combiner 250 may output the combined data signal to the core 260.

The core 260 processes the restored data signal. Also, the core may include various modules for performing functions of the receiver 200 in addition to functioning as a module for processing the restored data signal.

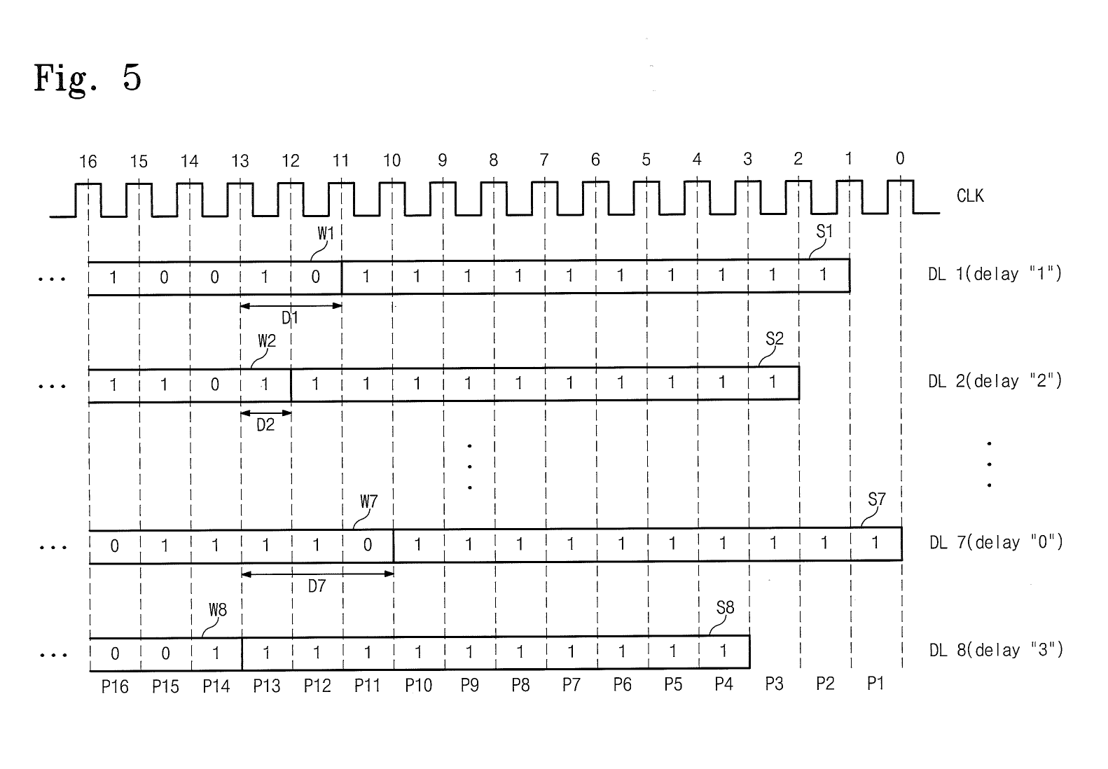

FIG. 5 is a view illustrating data signals received in the receiver shown in FIG. 4 according to some embodiments.

Referring to FIGS. 4 and 5, the detector 230 receives data signals of respective data lines DL1 to DLn. For example, a first data signal, a second data signal, a seventh data signal, and an eighth data signal received through eight data lines DL1 to DL8 are illustrated in FIG. 5.

The detector 230 detects start data. As one example, the start data may include 10 bits with all ‘1’s.

First, FIG. 5 indicates that the detector 230 detects an arrival time point of the seventh data signal. The detector 230 detects the seventh data signal at a time point P1.

Second, the detector 230 detects an arrival time point of a first data signal after one clock time elapses from the arrival time point of the seventh data signal. The detector 230 detects the first data signal at a time point P2. The first data signal has a transmission delay time corresponding to one clock time compared with the seventh data signal.

Third, after two clock times elapse from the arrival time point of the seventh data signal, the detector 230 detects an arrival time point of a second data signal. The detector 230 detects the second data signal at a time point P3. The second data signal has a transmission delay time corresponding to two clock times compared with the seventh data signal.

Fourth, the detector 230 detects an arrival time point of an eighth data signal after three clock times elapse from the arrival time point of the seventh data signal. The detector 230 detects the eighth data signal at a time point P4. The eighth data signal has a transmission delay time corresponding to three clock times compared with the seventh data signal.

The detector 230 outputs the detected arrival time points to the delay controller 240.

The delay controller 240 applies a delay time for delay compensation to each channel in consideration of arrival time points of the start data. Referring to FIG. 5, assuming that the eighth data signal is the last received data signal, the delay controller 240 may apply delay times to the other data signals based on comparisons of their arrival time points to the arrival time point of the eighth data signal.

FIG. 5 indicates that the first data signal has the arrival time point P2, whereas the eighth data signal has the arrival time point P4. Accordingly, in relation to first word data W1, the delay controller 240 outputs a first control signal CTRL1 to the first delay compensator 211, in order to apply a delay time D1 corresponding to two clock times. In relation to second word data W2, the delay controller 240 outputs a second control signal CTRL2 to apply a delay time D2 corresponding to one clock time to a second delay compensator (not shown). In relation to seventh word data W7, the delay controller 240 outputs a seventh control signal CTRL7 to apply a delay time D7 corresponding to three clock times to a seventh delay compensator (not shown). In relation to eighth word data W8, the delay controller 240 outputs an eighth control signal CTRL8 without an applied delay time to an eighth delay compensator (not shown).

Assuming the example of transmitting data signals through eight data lines DL1 to DL8, the delay compensator 220 includes a first delay compensator 221 to an eighth delay compensator (not shown).

In response to the first control signal CTRL1, the first delay compensator 221 applies the first delay time D1 to a first word data W1 received at a time point P12 and outputs it at a time point P14.

The second delay compensator (not shown) applies the second delay time D2 to a second word data W2 received at a time point P13 and outputs it at a time point P14.

The seventh delay compensator (not shown) applies the seventh delay time D7 to a seventh word data W7 received at a time point P11 and outputs it at a time point P14.

The eighth delay compensator (not shown) applies the eighth delay time D8 to an eighth word data W8 received at a time point P14 and outputs it at a time point P14. As such, the eighth delay compensator does not apply a delay time to the eighth word data.

The first delay compensator 221 to the eighth delay compensator (not shown) included in the delay compensator unit 220 may apply a corresponding delay time to each respective data signal. In some embodiments, however, the delay compensator unit 220 may not apply a delay time to the last-received data signal(s).

Accordingly, the delay controller 240 may control data signals (i.e., word data W1, W2, . . . , W7, W8) of data lines DL1 to DL8 to output the data signals at the same time point P14 through the first control signal CTRL1 to the eighth control signal CTRL8. Additionally, the delay controller 240 may control the next/following data signals (i.e., word data W9, W10, . . . , W15, W16) of data lines DL1 to DL8 to be output at the same time point P22.

In addition, the delay controller 240 may provide boundary information for detection of each data signal through the control signals CTRL1 to CTRL8. The boundary information may include a starting time point and/or an ending time point of each data signal.

For example, the first control signal CTRL1 may include a starting time point P12 and/or an ending time point P19 (not shown) of first word data W1. The second control signal CTRL2 may include a starting time point P13 and/or an ending time point P20 (not shown) of second word data. The seventh control signal CTRL7 may include a starting time point P11 and/or an ending time point P18 (not shown) of seventh word data. Additionally, the eighth control signal CTRL8 may include a starting time point P14 and/or an ending time point P21 (not shown) of eighth word data.

Moreover, the delay compensator 220 may perform a skew compensation operation on data signals using a control signal during a clock time corresponding to the length of start data.

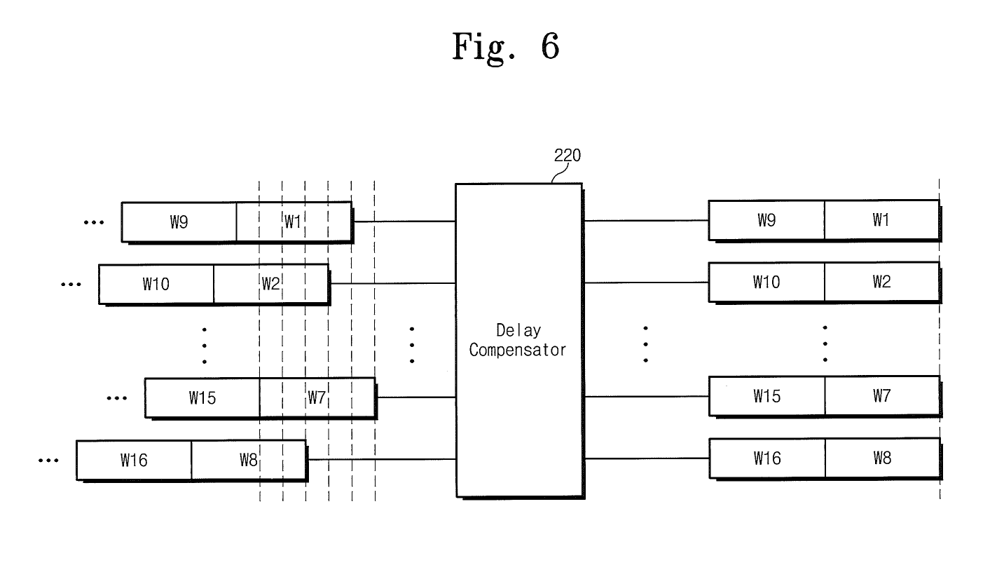

FIG. 6 is a view illustrating an operation for compensating for skew between data signals in the delay compensator shown in FIG. 4 according to some embodiments.

Referring to FIG. 6, the delay compensator 220 may receive data signals whose reception time points are not synchronized by each data line. Such data signals may include a first data signal (including first word data W1 and ninth word data W9), a second data signal (including second word data W2 and tenth word data W10), a seventh data signal (including seventh word data W7 and fifteenth word data W15), and an eighth data signal (including eighth word data W8 and sixteenth word data W16).

The delay compensator 220 compensates for delays of the first data signal, the second data signal, the seventh data signal, and the eighth data signal in response to control signals CTRL1 to CTRL8.

As a result, the data signals (i.e., the first data signal, the second data signal, the seventh data signal, and the eighth data signal) from the delay compensator 220 are output at the same time point.

Accordingly, the receiver 200 may compensate for skew of data signals whose arrival time points through a plurality of data lines are asynchronous. According to the skew compensation of the data signals, the receiver 200 may restore the original data signal accurately/normally.

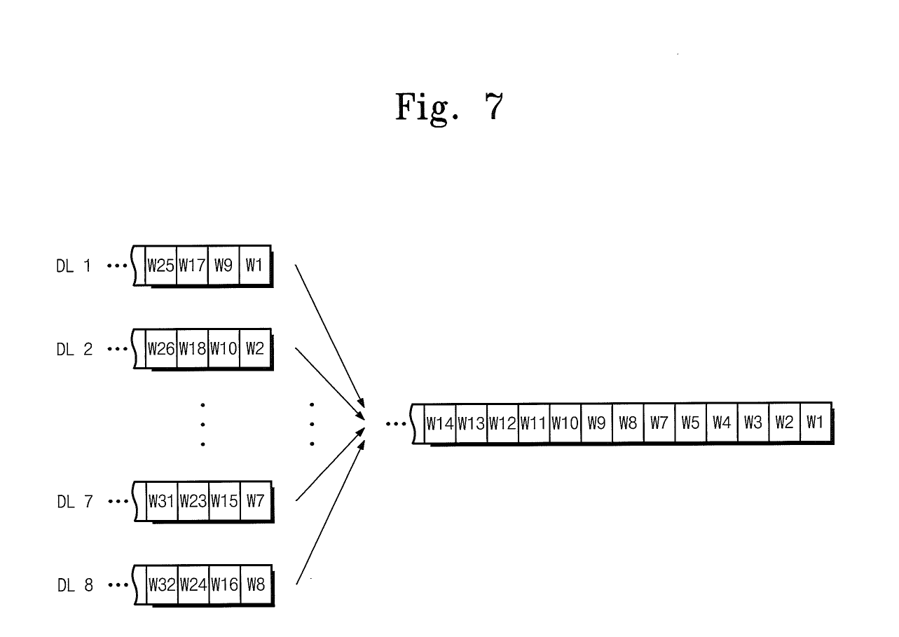

FIG. 7 is a view illustrating a combination operation of the combiner shown in FIG. 4 according to some embodiments.

Referring to FIGS. 4 and 7, the combiner 250 receives from the delay compensator 220 a plurality of data signals whose arrival time points are asynchronous but whose output time points from the delay compensator 220 are synchronous. For example, the combiner 250 may combine the data signals received through eight data lines DL1 to DL8.

The combiner 250 combines the received data by a unit, which may be determined based on each of the data signals. For example, the determined unit may be a word unit, i.e., a transmission unit.

The combiner 250 extracts first word data W1 from a first data signal. The combiner 250 extracts second word data W2 from a second data signal. The combiner 250 extracts seventh word data W7 from a seventh data signal. The combiner 250 extracts eighth word data W8 from an eighth data signal. In a similar method, the combiner 250 extracts word data from each of the remaining data signals.

The combiner 250 combines the word data extracted from data signals received after start data S1 to S8, according to an order corresponding to the data distributor 130. The combiner 250 thus may restore data signals through a combination of the word data W1, W2, W3, etc. transmitted from the transmitter 100.

A plurality of data lines according to some embodiments may be realized with a printed circuit board (PCB), a connector, a backplane wiring, an optical fiber, or a coaxial cable.

Moreover, according to the data transmission/reception system of some embodiments, the clock generator 110 of the transmitter 100 may be included in the receiver 200. Alternatively, if the clock generator 110 is external to the transmitter 100 and the receiver 200, a clock line CL may not exist between the transmitter 100 and the receiver 200.

The transmitter 100 and the receiver 200 may be included in one PCB or a system on a chip (SoC) or may be included in different PCBs or SoCs.

According to some embodiments, a receiver compensates for data skew by synchronizing reception time points between data received through a plurality of data lines. The receiver accurately/normally restores data transmitted from a transmitter by providing skew-compensated signals.

The above-disclosed subject matter is to be considered illustrative and not restrictive, and the appended claims are intended to cover all such modifications, enhancements, and other embodiments, which fall within the true spirit and scope of the disclosure.

Thus, to the maximum extent allowed by law, the scope of the disclosure is to be determined by the broadest permissible interpretation of the following claims and their equivalents, and shall not be restricted or limited by the foregoing detailed description.

What is claimed is:

1. A receiver comprising:
delay compensators connected to respective data lines;
a detector configured to detect arrival time points of respective data signals input through the data lines to provide detected arrival time points; and
a delay controller configured to control the delay compensators based on the detected arrival time points to output the data signals from the delay compensators at a same time point to provide delay-compensated data signals.

2. The receiver of claim 1, wherein each of the data signals comprises start data that represent a transmission start of the respective data signals.

3. The receiver of claim 2, wherein the detector is configured to detect different ones of the arrival time points using predetermined values of the start data.

4. The receiver of claim 1, wherein the delay controller is configured to delay the data signals based on the detected arrival time points.

5. The receiver of claim 4, wherein the delay controller is configured to delay each of the data signals except for at least one of the data signals having a latest one of the detected arrival time points.

6. The receiver of claim 1, further comprising buffers connected to the respective data lines, wherein the detector is connected between the buffers and the delay compensators.

7. The receiver of claim 1, further comprising a combiner configured to combine the delay-compensated data signals to provide a restored data signal.

8. The receiver of claim 7, further comprising a core configured to process the restored data signal.

9. The receiver of claim 7, wherein the combiner is configured to combine word units from the delay-compensated data signals to provide the restored data signal.

10. The receiver of claim 1, wherein the delay controller is further configured to provide boundary information for the data signals to the delay compensators.

11. The receiver of claim 10, wherein the boundary information includes starting time points and ending time points of word data included in the data signals.

12. A skew compensation method of a receiver, the method comprising:
detecting arrival time points of data signals input through respective data lines to provide detected arrival time points; and
controlling delay compensators receiving respective ones of the data signals based on the detected arrival time points to output the data signals at a same time point to provide delay-compensated data signals.

13. The method of claim 12, wherein each of the data signals comprises start data that represent a transmission start of the respective data signals.

14. The method of claim 13, wherein the detected arrival time points correspond to the start data.

15. The method of claim 12, wherein controlling the delay compensators further comprises delaying each of the data signals except for at least one of the data signals having a latest one of the detected arrival time points.

16. The method of claim 12, wherein controlling the delay compensators comprises delaying each of the data signals based on the detected arrival time points.

17. The method of claim 12, further comprising combining each of the delay-compensated data signals.

18. A transmission/reception system comprising:
a transmitter configured to transmit data signals through data lines, the data signals including start data that represent a transmission start of each of the respective data signals; and
a receiver configured to detect arrival time points of the start data to provide detected arrival time points, the receiver further configured to synchronize output time points of the data signals based on the detected arrival time points by delaying each of the data signals except for at least one of the data signals having a latest one of the detected arrival time points to provide delay-compensated data signals.

19. The transmission/reception system of claim 18, wherein the receiver comprises:
delay compensators connected to respective ones of the data lines;
a detector configured to detect the arrival time points of the data signals input through the respective data lines to provide the detected arrival time points; and
a delay controller configured to delay the data signals by controlling each of the delay compensators based on the detected arrival time points to output the delay-compensated data signals from the delay compensators at a same time point.

20. The transmission/reception system of claim 19, further comprising a combiner configured to combine the delay-compensated data signals.
